(19) United States
(12) Patent Application Publication
(10) Pub. No.: US 2026/0039000 A1
(43) Pub. Date: Feb. 5, 2026

(54) FILTER FOR COMMUNICATION DEVICE

(71) Applicant: KMW INC., Hwaseong-si (KR)

(72) Inventors: Joung Hoe KIM, Hwaseong-si (KR); Sung Ho JANG, Yongin-si (KR); Yeon Ho SHIN, Yongin-si (KR); Bo Sung KIM, Hwaseong-si (KR); Young Jin JUNG, Hwaseong-si (KR); Heok Jin SOHN, Osan-si (KR); Jae Hong KIM, Yongin-si (KR); Sang Yoong KIM, Hwaseong-si (KR)

(73) Assignee: KMW INC., Hwaseong-si (KR)

(21) Appl. No.: 19/353,588

(22) Filed: Oct. 8, 2025

Related U.S. Application Data
(63) Continuation of application No. PCT/KR2024/004678, filed on Apr. 9, 2024.

(30) Foreign Application Priority Data
Apr. 11, 2023 (KR) 10-2023-0047564

(51) Int. Cl. H01P 1/207; H01P 1/213

(52) U.S. Cl. CPC H01P 1/207; H01P 1/2138

(57) ABSTRACT

The present disclosure relates to a filter for a communication device including: a notch-forming portion formed to extend in a predetermined direction from any one of resonant elements: a base portion, a resonant leg portion, or a resonant plate, particularly to enable multi-pass coupling, wherein at least the resonant elements are provided to be fixed to a filter housing after being manufactured from a single base material plate through press and folding processes, thereby reducing the complexity of the filter and enabling implementation of various filter functions.

### TECHNICAL FIELD

The present disclosure relates to a filter for a communication device, and more particularly, to a filter for a communication device in which: a cavity may be formed by using a folding method in a preceding process; a plurality of resonators may be disposed to be spaced apart from one another inside the cavity; and a notch-forming portion, configured to form an L-notch portion through inductive coupling and a C-notch portion through capacitive coupling at both ends of a band-pass, may be provided adjacent to the resonators.

### BACKGROUND ART

A radio frequency device, such as a radio frequency filter (including all types of “communication devices”) is typically configured with a structure in which multiple resonators are connected. Such a resonator serves as a circuit element that resonates at a particular frequency through a combination of an inductor (L) and a capacitor (C) in an equivalent electronic circuit. Each resonator has a structure where a dielectric resonance element (DR) or a metallic resonance element is installed inside a cavity, such as a metallic cylinder or rectangular prism, enclosed by a conductor. Accordingly, each resonator has a structure that enables high-frequency resonance by ensuring that solely the electromagnetic field with an intrinsic frequency corresponding to the processing frequency band is present within its respective cavity. Typically, multiple cavities are used to form multiple resonant sections, and the multiple resonant sections form a multi-stage structure in which the resonant sections are sequentially connected.

An example of a radio frequency filter having a multi-cavity structure is disclosed in Korean Patent Application Publication No. 10-2004-0100084 (entitled “RADIO FREQUENCY FILTER” and published on Dec. 2, 2004), filed earlier by the applicant of the present application.

However, in a conventional radio frequency filter, each resonator is provided to extend in a thickness direction inside the cavity, and a portion of a filter tuning cover that covers the cavity is modified by using a stamping method to adjust a distance to the resonator in order to achieve desired bandpass characteristics, resulting in a significant limitation in size reduction of a completed filter in the thickness direction.

Furthermore, the conventional radio frequency filter requires installation of an additional conductive component to implement inductive or capacitive coupling between resonators adjacent to or spaced-apart from each other within multiple cavities in order to enhance skirt characteristics, resulting in a significant weight increase of the completed filter.

In addition, for an antenna device employing Massive Multiple Input Multiple Output (MIMO) technology, research is currently underway to minimize the thickness of internal components such as a filter, in order to achieve overall product slimming. The most frequently used type of filter for this purpose is a dielectric ceramic filter.

However, due to its material properties, the dielectric ceramic filter is coupled to be in direct contact with one surface of a main board (or PA board) stacked inside an antenna housing, thereby inevitably limiting the use of both sides of a printed circuit board (PCB).

### DISCLOSURE

### Technical Problem

The present disclosure is proposed to resolve the aforementioned technical issues and is directed to providing a filter for a communication device in which a cavity is formed by using a folding method, and a notch-forming portion with a simple and uncomplicated notch structure is constructed in the cavity's interior having a relatively small size in a thickness direction, thereby securing various frequency characteristics and thus facilitating the design of notches on both sides of a passband.

In addition, the present disclosure is also directed to providing a filter for a communication device, which may avoid the manufacture of a ceramic filter body, thereby improving the usability of both sides of a main board.

Technical issues of the present disclosure are not limited to the technical issues mentioned above, and other technical issues not mentioned above will be clearly understood by those skilled in the art from the following description.

### Technical Solution

A filter for a communication device according to an embodiment of the present disclosure having the configuration described above includes: a filter housing having a cavity formed to be elongated in a lengthwise direction therein and provided with an input port and an output port for electrical connection to one side and the other side of the cavity; and a resonant element fixed inside the filter housing and including an input port terminal connected to the input port and an output port terminal connected to the output port, wherein the resonant element includes: a base portion disposed to be elongated in the lengthwise direction on a lower side of the cavity in a thickness direction; a resonant leg portion folded from the base portion to extend toward an upper side of the cavity in the thickness direction; and a resonant plate disposed above the resonant leg portion and bent to extend parallel to an upper surface of the cavity in the thickness direction, wherein the filter further includes a notch-forming portion formed to extend in a predetermined direction from any one of the base portion, the resonant leg portion, or the resonant plate to enable multi-pass coupling.

Here, the notch-forming portion may include an L-notch portion configured to form a predetermined notch at a left end of a passband and a C-notch portion configured to form a predetermined notch at a right end of the passband.

In addition, the L-notch portion may form a closed loop from the base portion or the resonant leg portion, and may be formed to protrude in the thickness direction of the cavity.

In addition, the L-notch portion may form a closed loop from the resonant leg portion, and may be formed to protrude in a width direction of the cavity.

In addition, the L-notch portion may be formed on one side or the other side in a width direction of any one of a pair of the base portions or a pair of the resonant leg portions disposed to be spaced apart from each other in parallel in the width direction inside the cavity.

In addition, based on the L-notch portions being formed on the pair of the base portions and the pair of the resonant leg portions being provided, the pair of the resonant leg portions may be formed to be increasingly spaced apart from each other toward the thickness direction of the cavity, such that the resonant plate has a largest area.

In addition, based on the L-notch portions being formed on the pair of the base portions and the pair of the resonant leg portions being provided, the pair of the resonant leg portions may be formed to be increasingly spaced apart from each other toward the thickness direction of the cavity, such that the resonant plate has a largest area, wherein portions, where the L-notch portions are formed, may be formed to extend in parallel with each other.

In addition, based on defining a planar portion configured to connect upper ends of the pair of the resonant leg portions in the width direction as the resonant plate, the pair of the resonant leg portions may be formed to be folded after an inner portion of the resonant plate is cut out to secure an electric field value (C-value) greater than or equal to a predetermined value based on a total area of the resonant plate.

In addition, the L-notch portion may be provided inside the cavity to connect the resonant leg portions or base portions, which are lower ends of the resonant leg portions, to the respective resonant plates adjacent to each other in the lengthwise direction or to the respective resonant plates disposed with one or more resonant plates interposed therebetween along the lengthwise direction.

In addition, the L-notch portion may be bent and extended from a resonant plate of any one resonant element to be coupled, and further bent and extended to be connected to the inside of the filter housing corresponding to one side of another resonant element to be coupled.

In addition, the base portion may be singly disposed horizontally in the lengthwise direction inside the cavity, and the resonant leg portion may singly extend vertically in the thickness direction inside the cavity to be orthogonal to the base portion, and may be formed to be folded after an inner portion of the corresponding resonant plate is cut out.

In addition, the C-notch portion may be formed to extend toward adjacent resonant plates among the resonant plates sequentially disposed to be spaced apart a predetermined distance from one another in the lengthwise direction inside the cavity, such that the distance between the adjacent resonant plates is narrowed.

In addition, based on defining an end of the C-notch portion extending from any one of the adjacent resonant plates toward the other adjacent resonant plate as an one-side resonant end, and defining an end extending from the other adjacent resonant plate toward the any one of the adjacent resonant plates as an other-side resonant end, the one-side resonant end and the other-side resonant end may be formed to extend so as to have a mutually overlapping range in the width direction inside the cavity.

In addition, based on assuming that the resonant plate is formed such that the one end and the other end of the cavity in the lengthwise direction are positioned at mutually symmetrical distances relative to a center of the resonant leg portion, the one-side resonant end and the other-side resonant end may be formed to extend toward cut adjacent ends of the respective adjacent resonant plates, and may be formed to extend to symmetrical uncut ends of the resonant plates.

In addition, at least the resonant elements may be fixed to the filter housing after being manufactured from a single base material plate through press and folding processes.

### Advantageous Effects

With a filter for a communication device according to an embodiment of the present disclosure, a cavity is formed by using a folding method, and a notch-forming portion with a simple and uncomplicated notch structure is constructed in the cavity's interior having a relatively small size in a thickness direction, thereby securing various frequency characteristics and thus facilitating the design of notches on both sides of a passband.

### DESCRIPTION OF DRAWINGS

FIG. 1 is a perspective view showing an exterior appearance of a filter for a communication device according to a first embodiment of the present disclosure.

FIG. 2 is an exploded perspective view of FIG. 1.

FIG. 3 is a front view (a), a plan view (b), and a side view (c) of a resonant element and a notch-forming portion among the components shown in FIG. 2.

FIG. 4 is an exploded perspective view showing a filter for a communication device according to a second embodiment of the present disclosure.

FIG. 5 is a front view (a), a plan view (b), and a side view (c) of a resonant element and a notch-forming portion among the components shown in FIG. 4.

FIG. 6 is an exploded perspective view showing a filter for a communication device according to a third embodiment of the present disclosure.

FIG. 7 is a front view (a), a plan view (b), and a side view (c) of a resonant element and a notch-forming portion among the components shown in FIG. 6.

FIG. 8 is an exploded perspective view showing a filter for a communication device according to a fourth embodiment of the present disclosure.

FIG. 9 is a front view (a), a plan view (b), and a side view (c) of a resonant element and a notch-forming portion among the components shown in FIG. 8.

FIG. 10 is an exploded perspective view showing a filter for a communication device according to a fifth embodiment of the present disclosure.

FIG. 11 is a front view (a), a plan view (b), and a side view (c) of a resonant element and a notch-forming portion among the components shown in FIG. 10.

FIG. 12 is an exploded perspective view showing a filter for a communication device according to a sixth embodiment of the present disclosure.

FIG. 13 is a front view (a), a plan view (b), and a side view (c) of a resonant element and a notch-forming portion among the components shown in FIG. 12.

<Description of Reference Numerals>

| | |
|---|---|
| 100 to 600: filter for a communication device | |
| 105-1 to 105-5: resonator | |
| 110: base portion | 120: resonant leg portion |
| 140: resonant plate | |
| 150, 160, 170; notch-forming portion | |
| 150,160: L-notch portion | 170: C-notch portion |

### BEST MODE

The advantages and features of the present disclosure, and methods of achieving the same will become apparent from the embodiments described in detail below with reference to the accompanying drawings. However the present disclosure is not limited to the embodiments disclosed below and may be implemented in various other forms. The present embodiments are provided to fully disclose the present disclosure and enable those skilled in the art to appreciate the full scope of the present disclosure. The present disclosure should be defined solely by the appended claims. As used herein, the same reference numerals refer to the same elements.

Embodiments of the present disclosure will be described in detail below with reference to the accompanying drawings.

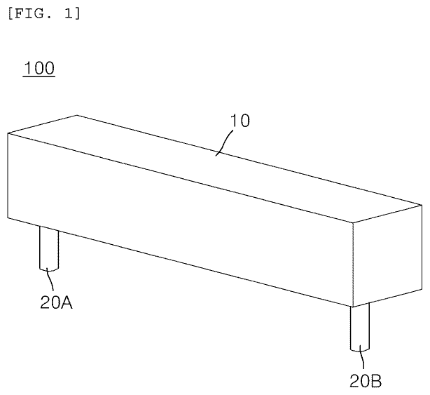

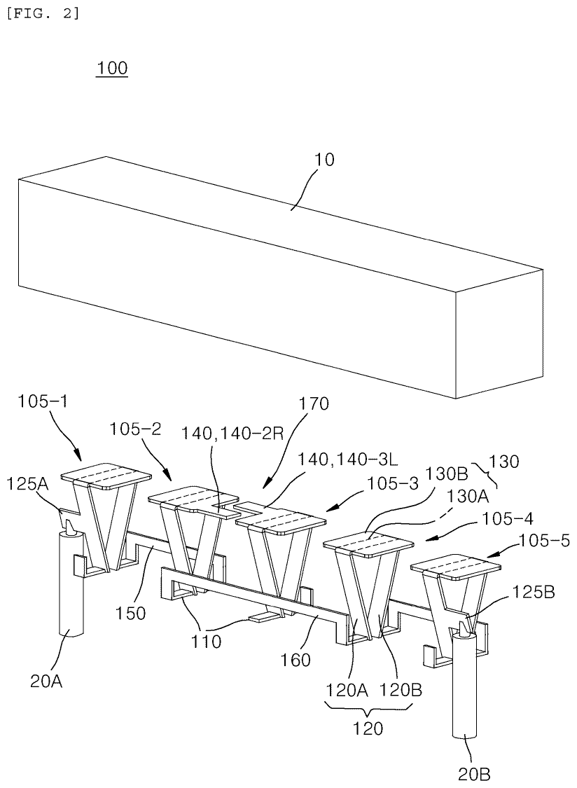

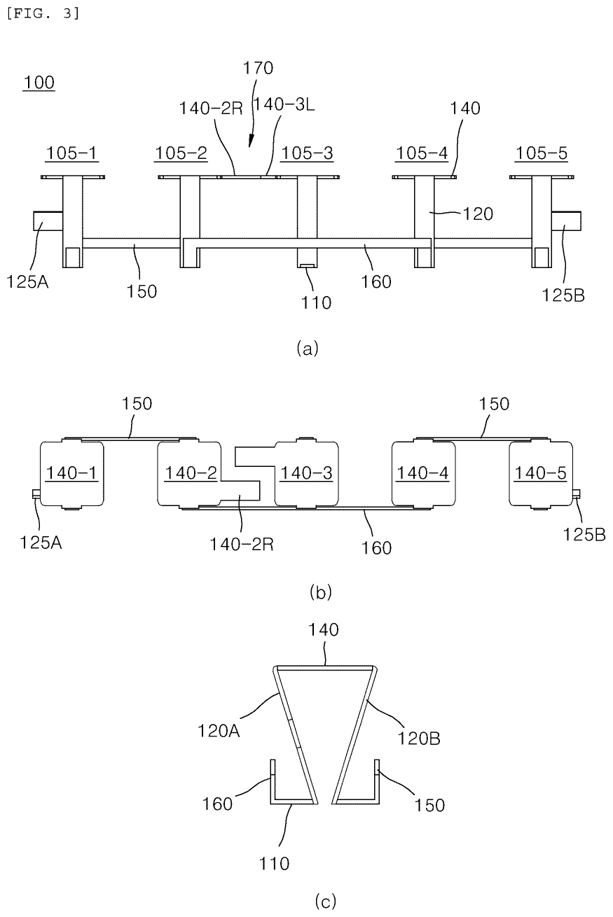

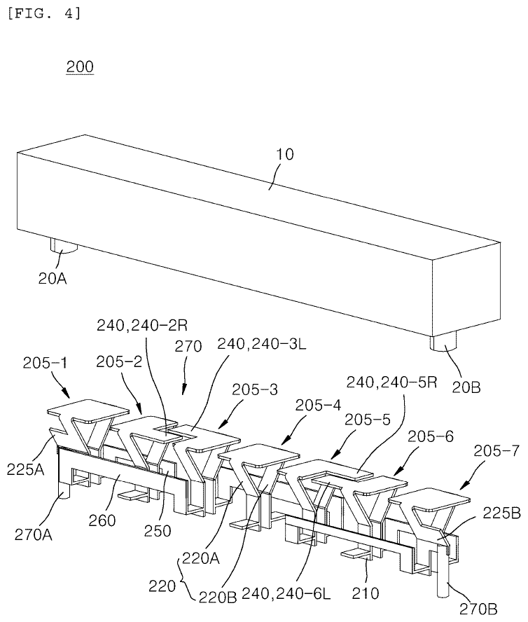

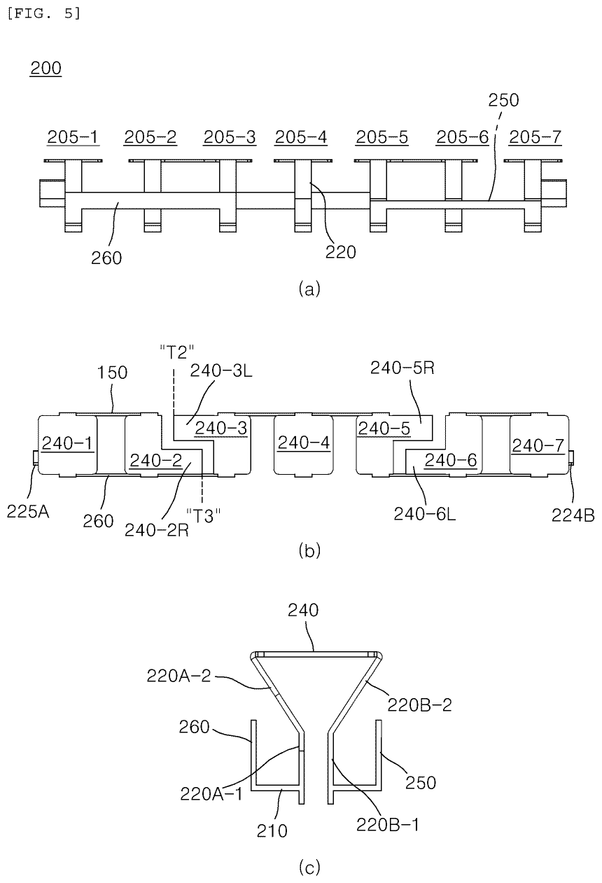

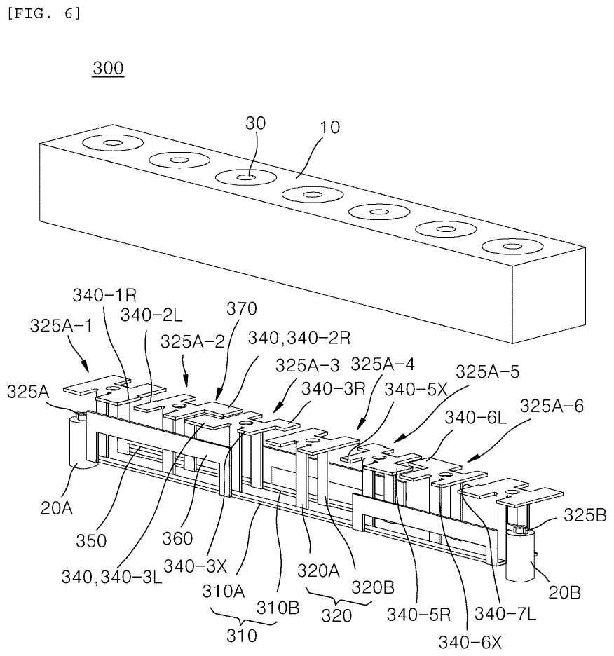

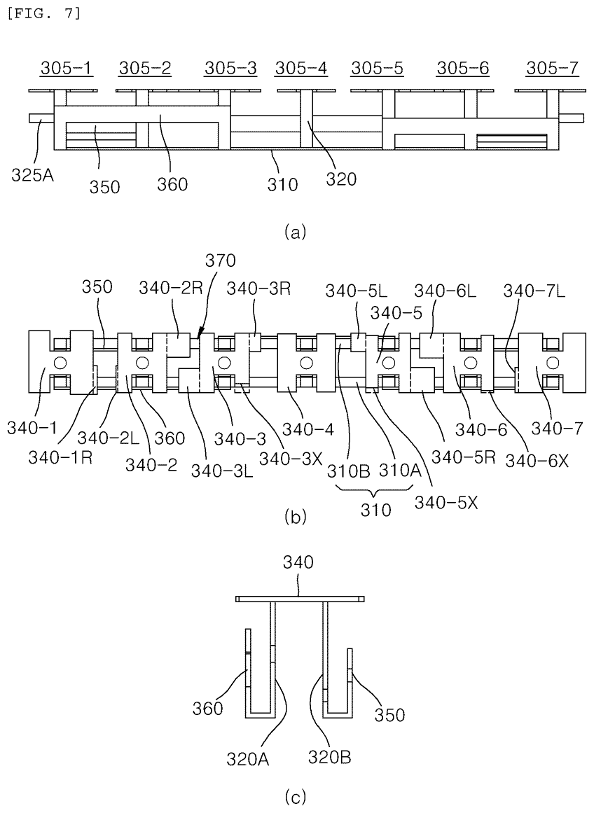

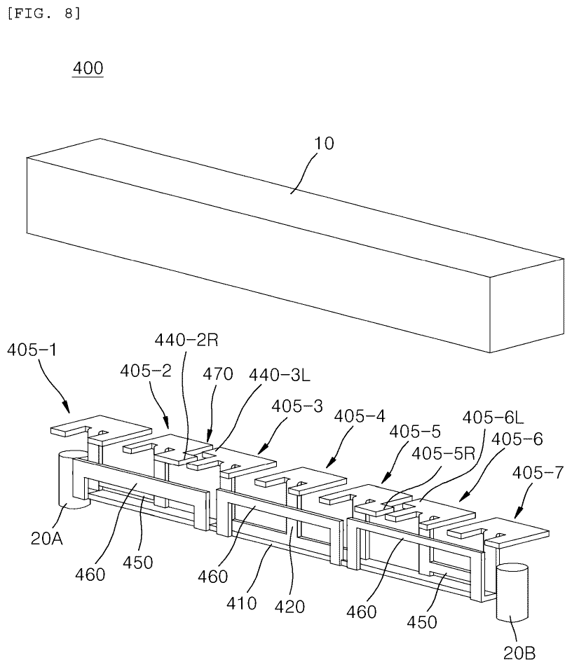

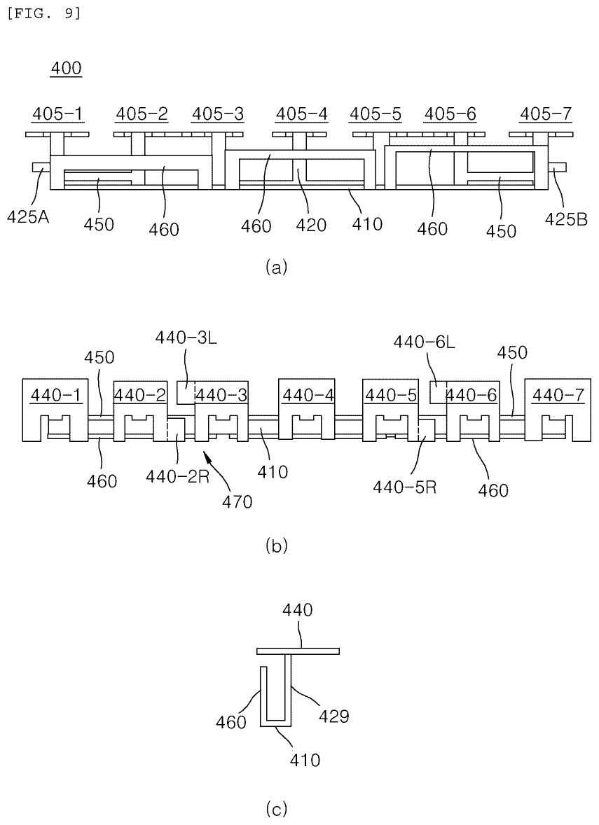

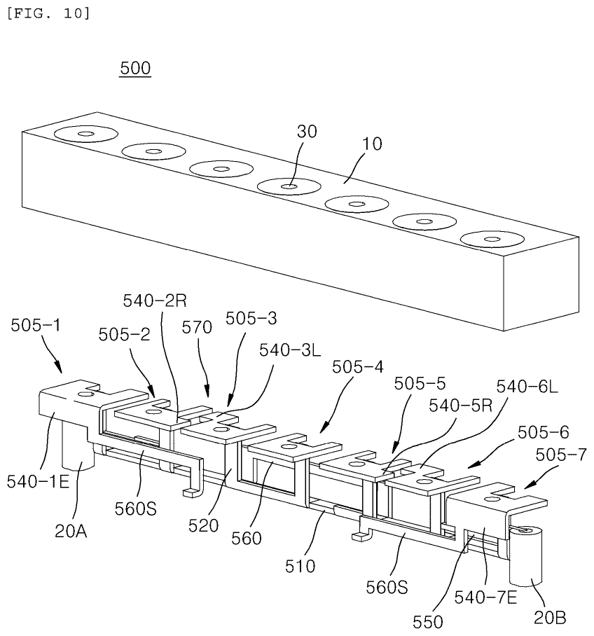

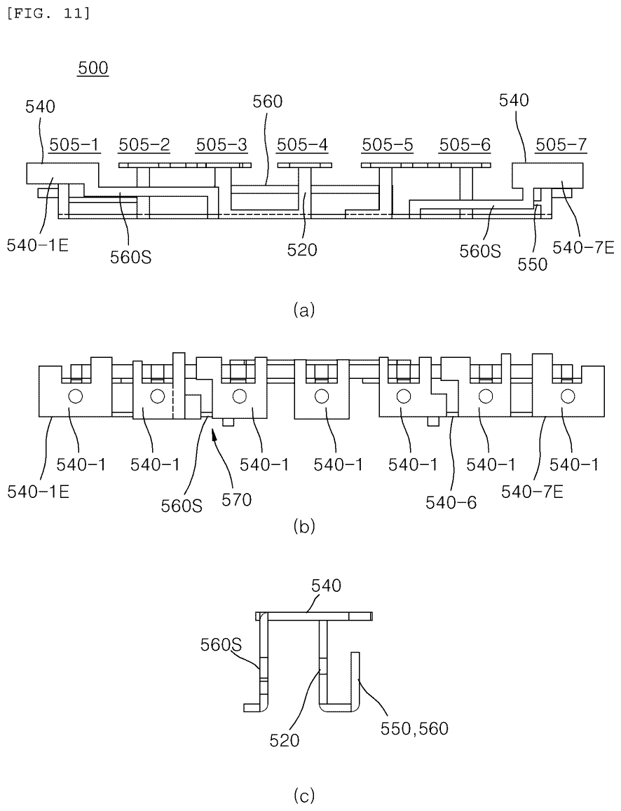

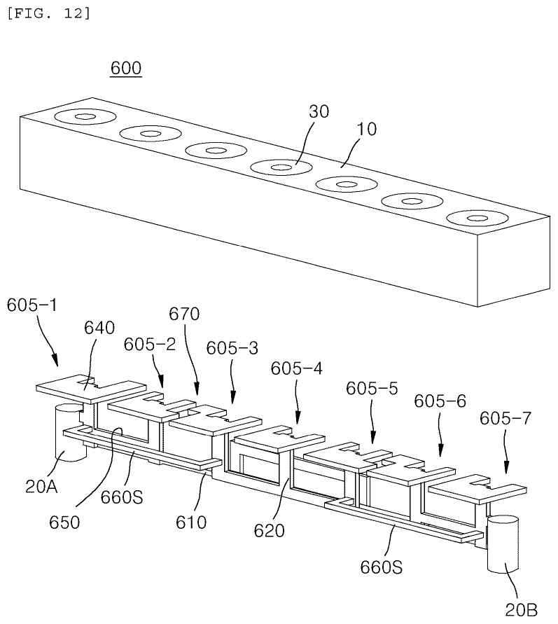

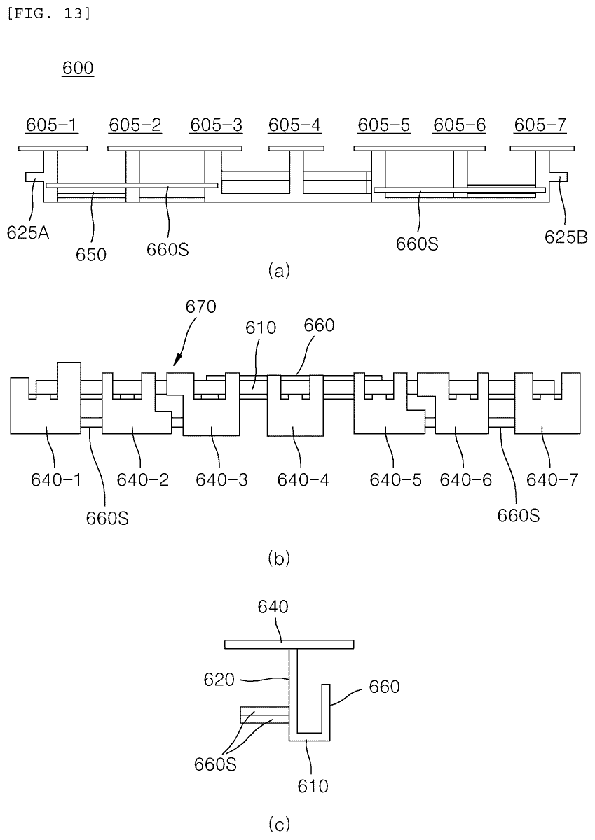

FIG. 1 is a perspective view showing an exterior appearance of a filter for a communication device according to a first embodiment of the present disclosure. FIG. 2 is an exploded perspective view of FIG. 1. FIG. 3 is a front view (a), a plan view (b), and a side view (c) of a resonant element and a notch-forming portion among the components shown in FIG. 2. FIG. 4 is an exploded perspective view showing a filter for a communication device according to a second embodiment of the present disclosure. FIG. 5 is a front view (a), a plan view (b), and a side view (c) of a resonant element and a notch-forming portion among the components shown in FIG. 4. FIG. 6 is an exploded perspective view showing a filter for a communication device according to a third embodiment of the present disclosure. FIG. 7 is a front view (a), a plan view (b), and a side view (c) of a resonant element and a notch-forming portion among the components shown in FIG. 6. FIG. 8 is an exploded perspective view showing a filter for a communication device according to a fourth embodiment of the present disclosure. FIG. 9 is a front view (a), a plan view (b), and a side view (c) of a resonant element and a notch-forming portion among the components shown in FIG. 8. FIG. 10 is an exploded perspective view showing a filter for a communication device according to a fifth embodiment of the present disclosure. FIG. 11 is a front view (a), a plan view (b), and a side view (c) of a resonant element and a notch-forming portion among the components shown in FIG. 10. FIG. 12 is an exploded perspective view showing a filter for a communication device according to a sixth embodiment of the present disclosure. FIG. 13 is a front view (a), a plan view (b), and a side view (c) of a resonant element and a notch-forming portion among the components shown in FIG. 12.

An antenna for communication includes a filter for filtering signals in a particular passband. Depending on the characteristics, a cavity filter, a waveguide filter, or the like may be used as the filter. However, in the embodiments of the present disclosure, the filter is a type of cavity filter having a cavity that may be filled with a dielectric material, such as air. In the following description, key components of the cavity filter are resonant elements, excluding a filter housing, which are formed from a single base material plate and installed by using a folding method within the cavity that serves as a primary transmission path of signals.

In general, in the field of antenna technology, a filter is a communication component that performs a function of filtering solely signals in a particular frequency band among signals to be input or output during signal transmission and reception, thereby ensuring that solely a signal desired by a consumer (user) is obtained as a result value.

For the signal filtering, a cavity filter, as indicated by its name, forms a cavity, which is a predetermined signal filtering region (signal transmission path), between an input port into which a signal is input and an output port from which the signal is output. By tuning the frequency through the cavity, the filter enables acquisition of a signal value within a particular frequency band range desired by the consumer.

However, in the antenna device manufacturing industry, the only method that has been developed and disclosed to date involves: processing an interior of a filter body made of a ceramic material (dielectric material) or a more rigid material to manufacture the cavity described above and subsequently manufacturing essential components for frequency filtering, such as a plurality of resonators; and then fixing the essential components inside the cavity.

However, filters for a communication device 100 to 600 according to the embodiments of the present disclosure may be manufactured as a cavity filter by departing from the above-described manufacturing method and, instead, by using a method involving: processing a single flat base material plate having a thickness not exceeding a predetermined value by using a press method and subsequently manufacturing all or part of resonant elements, which are structures inside the cavity, through a folding process; and then coupling the resonant elements to a filter housing 10.

The filter housing 10 may be manufactured such that a cavity is formed inside a metal plate by using a molding or folding method, or a cavity is formed inside a general resin material by using a molding method, and then a predetermined conductive film is formed on an inner or outer surface of the cavity.

Here, a portion of the filter housing 10 covering an upper side of the cavity in a thickness direction is typically manufactured separately as a filter cover and then coupled. As shown in FIGS. 6, 10, and 12, the filter cover may be provided with a frequency tuning portion 30 for fine frequency tuning by using a stamping method.

In addition, a cavity refers to a dielectric-filled space intended to be filled with a dielectric material having a predetermined permittivity. That is, a cavity is a space having an empty interior to allow the dielectric to be filled. It should be noted in advance that air is also a type of dielectric with a permittivity of 1, and thus adopting air at atmospheric pressure as the dielectric does not require a separate dielectric-filling process.

The filters for a communication device 100 to 600 according to embodiments of the present disclosure, as shown in FIGS. 1 to 13, include: the filter housing 10, which has a cavity formed to be elongated in a lengthwise direction therein and is provided with an input port 20A and an output port 20B for electrical connection to one side and the other side of the cavity; and a resonant element (reference numerals not shown), which is fixed inside the filter housing 10 and includes an input port terminal 125A connected to the input port 20A and an output port terminal 125B connected to the output port 20B.

Here, the resonant element includes: a base portion 110, which is disposed to be elongated in the lengthwise direction on a lower side of the cavity in a thickness direction; a resonant leg portion 120, which is folded from the base portion 110 and extends toward an upper side of the cavity in the thickness direction; and a resonant plate 140, which is disposed above the resonant leg portion 120 and bent to extend parallel to an upper surface of the cavity in the thickness direction.

The base portion 110, the resonant leg portion 120, and the resonant plate 140 may be manufactured from a single base material plate through a press process and subsequently formed into a three-dimensional resonant element through a folding process, and then coupled and fixed, in various manners, to the inside of the cavity of the filter housing 10.

A plurality of the resonant leg portions 120 and the resonant plates 140 are sequentially disposed to be spaced apart from each other in the lengthwise direction of the cavity, such that during a process in which an electrical signal is applied from the input port terminal 125A on one side of the cavity and output through the output port terminal 125B on the other side of the cavity, filtering in a predetermined frequency band is performed.

In addition, as shown in FIGS. 1 to 13, the filters for a communication device 100 to 600 according to the embodiments of the present disclosure may further include notch-forming portions 150, 160, and 170 formed to extend in a predetermined direction from any one of the base portion 110, the resonant leg portion 120, or the resonant plate 140, to enable multi-pass coupling.

The filters for a communication device 100 to 600 according to the embodiments of the present disclosure will be sequentially described in detail below. However, in the sequential description of each embodiment, overlapping parts will be described by indicating only by their reference numerals of the components according to the corresponding description, and the description of overlapping features that have been previously described will be omitted.

First, the filter for a communication device 100 according to the first embodiment of the present disclosure may include the notch-forming portions 150, 160, and 170, as shown in FIGS. 1 to 3.

The notch-forming portions 150, 160, and 170 may include the L-notch portions 150 and 160, which form a predetermined notch at a left end of a passband and the C-notch portion 170, which forms a predetermined notch at a right end of the passband.

It will be readily understood that the formation positions and shapes of the notch-forming portions 150, 160, and 170 are not necessarily predetermined, and that various designs as described below are possible depending on a position and selection of resonators associated with the multi-path coupling.

Here, the L-notch portions 150 and 160 may form a closed loop from the base portion 110 and may be formed to protrude in the thickness direction of the cavity.

However, the L-notch portions 150 and 160 are not necessarily required to be formed to extend and protrude from the base portion 110, and may also be formed to protrude from the resonant leg portion 220, as in the second embodiment (200), which will be described later.

That is, L-notch portions 250 and 260 may be formed to extend from the resonant leg portion 220 to form a closed loop, as shown in FIGS. 4 and 5. In this case, at least a portion of L-notch portions 650 and 660S may form a closed loop from a resonant leg portion 620 and protrude solely in a width direction of the cavity without protruding in a thickness direction of the cavity, as shown in FIG. 12.

In addition, the L-notch portions 150 and 160 may be formed on one side or the other side in the width direction of any one of a pair of the base portions 110 or a pair of resonant leg portions 120A and 120B disposed to be spaced apart from each other in parallel in the width direction inside the cavity.

Here, if the L-notch portions 150 and 160 are formed on the pair of the base portions 110, and a pair of the resonant leg portions 120 are also provided, the pair of resonant leg portions 120A and 120B may be formed to be increasingly spaced apart from each other toward the thickness direction of the cavity. Accordingly, the resonant plate 140, which is configured to connect upper ends of the pair of the resonant leg portions 120 horizontally, may have a largest area.

In this manner, in response to the pair of resonant leg portions 120A and 120B being increasingly spaced apart from each other toward the upper side of the cavity in the thickness direction, a favorable Q value, which controls the frequency band altered by the filter, may be secured. That is, the higher the Q value, the narrower the bandwidth of the frequency band altered around the cutoff frequency, and thus the frequency selectivity of the circuit is also generally improved.

However, a pair of resonant leg portions 220A and 220B are not necessarily required to be formed such that a distance therebetween gradually increases toward the upper side of the cavity in the thickness direction. As shown in FIGS. 4 and 5, portions 220A-1 and 220B-1 where the L-notch portions 250 and 260 are formed may be formed to extend parallel to each other, so as to further improve a transmission rate of signals transmitted from the L-notch portions 250 and 260.

More specifically, a portion of the lower end portions of the pair of resonant leg portions 220A and 220B may be formed parallel to the L-notch portions 250 and 260, which are disposed in a vertically oriented and parallel manner at least inside the cavity.

In addition, as shown in FIGS. 2 and 3, the L-notch portions 150 and 160 may be provided inside the cavity to connect the resonant leg portions 120A and 120B or the base portion 110, which are lower ends of the resonant leg portions 120A and 120B, to the respective resonant plates adjacent to each other in the lengthwise direction (e.g., a first resonator 105-1 and a second resonator 105-2) or to the respective resonant plates disposed with one or more resonant plates interposed therebetween along the lengthwise direction (e.g., a second resonator 105-2 and a fourth resonator 105-4).

Hereinafter, the former will be referred to as an “adjacent L-notch portion” and designated by reference numeral 150, and the latter will be referred to a “cross L-notch portion” and designated by reference numeral 160.

In addition, as shown in FIGS. 6 and 7, in the filter for a communication device 300 according to the third embodiment of the present disclosure, based on defining a planar portion connecting upper ends of a pair of resonant leg portions 320A and 320B in the width direction as a resonant plate 340, the pair of resonant leg portions 320A and 320B may be formed to be folded after an inner portion of the resonant plate 340 is cut out to secure an electric field value (C-value) greater than or equal to a predetermined value based on a total area of the resonant plate 340.

However, the shape of the L-notch portions 150 and 160 is not necessarily limited to the above-described configuration. As in the filter for a communication device 500 according to the fifth embodiment of the present disclosure (see FIGS. 10 and 11), a L-notch portion 560S may be bent and extended from a resonant plate of any one resonant element to be coupled (e.g., a resonant plate 540 of a first resonator 505-1 or a seventh resonator 505-7), and further bent and extended to be connected to the inside of the filter housing 10 corresponding to one side of another resonant element to be coupled.

In this case, as shown in FIGS. 10 and 11, one end of the L-notch portion 560S may be integrally connected to a connection end (540-1E or 540-7E) bent and extended from the resonant plate 540 of the first resonator 505-1 or the seventh resonator 505-7, and may extend horizontally along the lengthwise direction of the cavity to a position where a third resonator 505-3 or a fourth resonator 505-4 to be coupled is formed, and then the other end of the L-notch portion 560S may be connected and fixed to the inside of the filter housing 10.

In addition, in the filters for a communication device 400, 500, and 600 according to the fourth to sixth embodiments of the present disclosure, the base portion 410, 510, or 610 may be singly disposed horizontally in the lengthwise direction inside the cavity; and the resonant leg portion 420, 520, or 620 may singly extend vertically in the thickness direction inside the cavity to be orthogonal to the corresponding base portion 410, 510, or 610, and may be formed to be folded after an inner portion of the corresponding resonant plates 440, 540, or 640 is cut out.

In addition, in the filters for a communication device 100 to 600 according to the embodiments of the present disclosure, as shown in FIGS. 2 to 13, the C-notch portion 170 may be formed to extend toward adjacent resonant plates (e.g., a resonant plate of the second resonator 105-2 and a resonant plate of a third resonator 105-3 in FIG. 2) among the resonant plates sequentially disposed to be spaced apart a predetermined distance from one another in the lengthwise direction inside the cavity, such that the distance between the adjacent resonant plates is narrowed.

Here, an end of the C-notch portion 170 extending from any one of the adjacent resonant plates (e.g., the resonant plate of the second resonator 105-2 in FIG. 2) toward the other adjacent resonant plate (e.g., the resonant plate of the third resonator 105-3 in FIG. 2) is defined as an one-side resonant end 140-2R; and an end of the C-notch portion 170 extending from the other adjacent resonant plate (e.g., the resonant plate of the third resonator 105-3 in FIG. 2) toward the any one of the adjacent resonant plates (e.g., the resonant plate of the second resonator 105-2 in FIG. 2) is defined as an other-side resonant end 140-3L. In this case, the one-side resonant end 140-2R and the other-side resonant end 140-3L may be formed to extend so as to have a mutually overlapping range in the width direction inside the cavity.

In this case, as shown in FIGS. 4 and 5, based on assuming that a resonant plate 240 is formed such that one end and the other end of the cavity in the lengthwise direction are positioned at mutually symmetrical distances relative to a center of the resonant leg portion 220, an one-side resonant end 240-2R and an other-side resonant end 240-3L may be formed to extend toward cut adjacent ends of the respective adjacent resonant plates, and may be formed to extend to symmetrical uncut ends of the resonant plates (see reference numerals “T2” and “T3” in FIG. 5).

More specifically, a cut adjacent end of a resonant plate 240-2 of a second resonator 205-2 is a point indicated by “T2” and a cut adjacent end of a resonant plate 240-3 of a third resonator 205-3 is a point indicated by “T3.” In this case, a tip of the one-side resonant end 240-2R formed on the second resonator 205-2 may extend at least to a point corresponding to “T3,” and a tip of the other-side resonant end 240-3L formed on the third resonator 205-3 may extend at least to a point corresponding to “T2.”

Although all the components constituting the embodiments of the present disclosure have been described as being combined to operate as a single unit, the present disclosure is not necessarily limited to the embodiments. Within the scope of the present disclosure, depending on the embodiment, one or more of the components may be selectively combined and operated.

The above description is merely an exemplary description of the technical spirit of the present disclosure, and it will be apparent to those skilled in the art that various modifications and variations are possible without departing from the essential features of the present disclosure.

### INDUSTRIAL APPLICABILITY

The present disclosure provides a filter for a communication device in which: a cavity may be formed by using a folding method in a preceding process; a plurality of resonators may be disposed to be spaced apart from one another inside the cavity; and a notch-forming portion, configured to form an L-notch portion through inductive coupling and a C-notch portion through capacitive coupling at both ends of a band-pass, may be provided adjacent to the resonators.

1. A filter for a communication device, the filter comprising:
a filter housing having a cavity formed to be elongated in a lengthwise direction therein and provided with an input port and an output port for electrical connection to one side and the other side of the cavity; and
a resonant element fixed inside the filter housing and comprising an input port terminal connected to the input port and an output port terminal connected to the output port,
wherein the resonant element comprises:
a base portion disposed to be elongated in the lengthwise direction on a lower side of the cavity in a thickness direction;
a resonant leg portion folded from the base portion to extend toward an upper side of the cavity in the thickness direction; and
a resonant plate disposed above the resonant leg portion and bent to extend parallel to an upper surface of the cavity in the thickness direction,
wherein the filter further comprises a notch-forming portion formed to extend in a predetermined direction from any one of the base portion, the resonant leg portion, or the resonant plate to enable multi-pass coupling.

2. The filter of claim 1, wherein the notch-forming portion comprises an L-notch portion configured to form a predetermined notch at a left end of a passband and a C-notch portion configured to form a predetermined notch at a right end of the passband.

3. The filter of claim 2, wherein the L-notch portion forms a closed loop from the base portion or the resonant leg portion, and is formed to protrude in the thickness direction of the cavity.

4. The filter of claim 2, wherein the L-notch portion forms a closed loop from the resonant leg portion, and is formed to protrude in a width direction of the cavity.

5. The filter of claim 3, wherein the L-notch portion is formed on one side or the other side in a width direction of any one of a pair of the base portions or a pair of the resonant leg portions disposed to be spaced apart from each other in parallel in the width direction inside the cavity.

6. The filter of claim 5, wherein based on the L-notch portions being formed on the pair of the base portions and the pair of the resonant leg portions being provided, the pair of the resonant leg portions are formed to be increasingly spaced apart from each other toward the thickness direction of the cavity, such that the resonant plate has a largest area.

7. The filter of claim 5, wherein based on the L-notch portions being formed on the pair of the base portions and the pair of the resonant leg portions being provided, the pair of the resonant leg portions are formed to be increasingly spaced apart from each other toward the thickness direction of the cavity, such that the resonant plate has a largest area, wherein portions, where the L-notch portions are formed, are formed to extend in parallel with each other.

8. The filter of claim 5, wherein based on defining a planar portion configured to connect upper ends of the pair of the resonant leg portions in the width direction as the resonant plate, the pair of the resonant leg portions are formed to be folded after an inner portion of the resonant plate is cut out to secure an electric field value (C-value) greater than or equal to a predetermined value based on a total area of the resonant plate.

9. The filter of claim 2, wherein the L-notch portion is provided inside the cavity to connect the resonant leg portions or base portions, which are lower ends of the resonant leg portions, to the respective resonant plates adjacent to each other in the lengthwise direction or to the respective resonant plates disposed with one or more resonant plates interposed therebetween along the lengthwise direction.

10. The filter of claim 2, wherein the L-notch portion is bent and extended from a resonant plate of any one resonant element to be coupled, and further bent and extended to be connected to the inside of the filter housing corresponding to one side of another resonant element to be coupled.

11. The filter of claim 3, wherein:
the base portion is singly disposed horizontally in the lengthwise direction inside the cavity, and
the resonant leg portion singly extends vertically in the thickness direction inside the cavity to be orthogonal to the base portion, and is formed to be folded after an inner portion of the corresponding resonant plate is cut out.

12. The filter of claim 2, wherein the C-notch portion is formed to extend toward adjacent resonant plates among the resonant plates sequentially disposed to be spaced apart a predetermined distance from one another in the lengthwise direction inside the cavity, such that the distance between the adjacent resonant plates is narrowed.

13. The filter of claim 12, wherein based on defining an end of the C-notch portion extending from any one of the adjacent resonant plates toward the other adjacent resonant plate as an one-side resonant end, and defining an end extending from the other adjacent resonant plate toward the any one of the adjacent resonant plates as an other-side resonant end, the one-side resonant end and the other-side resonant end are formed to extend so as to have a mutually overlapping range in the width direction inside the cavity.

14. The filter of claim 13, wherein based on assuming that the resonant plate is formed such that the one end and the other end of the cavity in the lengthwise direction are positioned at mutually symmetrical distances relative to a center of the resonant leg portion, the one-side resonant end and the other-side resonant end are formed to extend toward cut adjacent ends of the respective adjacent resonant plates, and are formed to extend to symmetrical uncut ends of the resonant plates.

15. The filter of claim 1, wherein at least the resonant elements are fixed to the filter housing after being manufactured from a single base material plate through press and folding processes.
